(19) United States
(12) Patent Application Publication
(10) Pub. No.: US 2006/0191898 A1
(43) Pub. Date: Aug. 31, 2006

(54) Fun ramps

(76) Inventor: Donald V. Edwards, Harrison City, PA (US)

Correspondence Address: JAMES RAY & ASSOCIATES, 2640 Pitcairn Road, Monroeville, PA, 15146, US

(21) Appl. No.: 11/355,752

(22) Filed: Feb. 16, 2006

Related U.S. Application Data
(60) Provisional application No. 60/653,431, filed on Feb. 16, 2005.

(51) Int. Cl. H05B 1/02

(52) U.S. Cl. 219/497

(57) ABSTRACT

A ramp system for recreational use. The ramp system comprises at least one member having each of a predetermined shape, a predetermined size and a plurality of substantially planar exterior surfaces, a first portion of the at least one member having an upper surface disposed in a substantially horizontal plane and a second portion disposed in a descending sloped plane, such upper surface being one of covered and uncovered.

### CROSS REFERENCE TO RELATED APPLICATIONS

This application is closely related to and claims benefit from U.S. Provisional Application Ser. No. 60/653,431 filed Feb. 16, 2005.

### FIELD OF THE INVENTION

The present invention relates, in general, to a ramp system used for recreational purposes and, more particularly, the present invention relates to a ramp system used in combination with fun slides to provide enhanced pleasure for the users.

### BACKGROUND OF THE INVENTION

Prior to the conception and development of the present invention ramp systems were developed primarily for skate board enthusiasts. Ramp structures were developed to enable skate boarders to perform various feats using the ramps to provide the impetus for the skaters to propel themselves.

However, all previous amusement ramps or ramp systems were constructed with the purpose of providing an area for skate boards. These ramps required wheeled vehicles such as skate boards or roller skates.

### SUMMARY OF THE INVENTION

In a first aspect the present invention provides a ramp system for recreational use. The ramp system comprises at least one member having each of a predetermined shape, a predetermined size and a plurality of substantially planar exterior surfaces, a first portion of the at least one member having an upper surface disposed in a substantially horizontal plane and a second portion disposed in a descending sloped plane, such upper surface being one of covered and uncovered.

In a second aspect the present invention provides a ramp system for recreational use. The ramp system comprises at least one first member having each of a first predetermined shape, a predetermined size and a plurality of substantially planar exterior surfaces, the first member having an upper surface having at least a first portion thereof disposed in a substantially horizontal plane. There is a second member having each of a second predetermined shape, a first predetermined width and a first predetermined length and having a first edge engageable with and extending outwardly from an upper surface of the at least one first member, the second member having an inclined surface.

In a third aspect the present invention provides a ramp system for recreational use. The ramp system comprises at least one first module having a first predetermined shape, a predetermined height and a predetermined size and having a plurality of substantially planar exterior surfaces. There is a second member having a second predetermined shape, a predetermined width and a predetermined length and engageable with an upper surface of the at least one first module, the second member extending outwardly therefrom, the second predetermined shape having a first portion extending downwardly, a second portion engageable with the first portion and extending outwardly from a second end of the first portion and rising upwardly therefrom and having an arcuate shape, the second portion being substantially in a shape of a horseshoe, and a third portion having a first end engageable with a second end of the second portion and being sloped downwardly to a supporting surface.

### OBJECTS OF THE INVENTION

It is, therefore, one of the primary objects of the present invention to provide a ramp system which can be used with fun skates.

Another object of the present invention is to provide a ramp system wherein the ramps are covered with a fabric type material.

Still another object of the present invention is to provide a ramp system wherein various types of ramps can be used.

A further object of the present invention is to provide a ramp system that is designed for recreational use.

An additional object of the present invention is to provide a ramp system that can be used with hard surface fun skates.

In addition to the various objects and advantages of the invention which have been described in some specific detail above it should be noted that various other objects and advantages of the present invention will become more readily apparent to those persons who are skilled in the relevant art from the following more detailed description, particularly, when such description is taken in conjunction with the attached drawing Figures and with the appended claims.

### BRIEF DESCRIPTION OF THE DRAWINGS

FIG. 1 is a partial perspective view of the apparatus according to an embodiment of the invention.

FIG. 2 is a partial perspective view of the apparatus according to an alternate embodiment of the invention having a carpeted exterior.

FIG. 3 is a partial perspective view of the apparatus according to an alternate embodiment of the invention where the units are modular with a carpeted exterior.

FIG. 4 is a partial perspective view of the apparatus according to an alternate embodiment of the invention where the units are modular and units are stacked with a carpeted exterior.

FIG. 5 is a partial perspective view of the apparatus according to an alternate embodiment of the invention where the units are modular and having a an exterior hard surface

FIG. 6 is a partial perspective view of the apparatus according to an alternate embodiment of the invention where the units are modular and stacked and having an exterior hard surface.

FIG. 7 is a partial perspective view of the apparatus according to an alternate embodiment of the invention where the ramp has undulations.

FIG. 8 is a top view of a fun ramp according to yet another embodiment.

FIG. 9 is a partial perspective view of the fun ramp shown in FIG. 8 according to yet another embodiment of the invention.

### BRIEF DESCRIPTION OF THE PRESENTLY PREFERRED AND VARIOUS ALTERNATIVE EMBODIMENTS OF THE INVENTION

Prior to proceeding to the more detailed description of the invention, it should be noted that identical components having identical functions have been designated with identical reference numerals throughout the several views illustrated in the drawings for the sake of clarity.

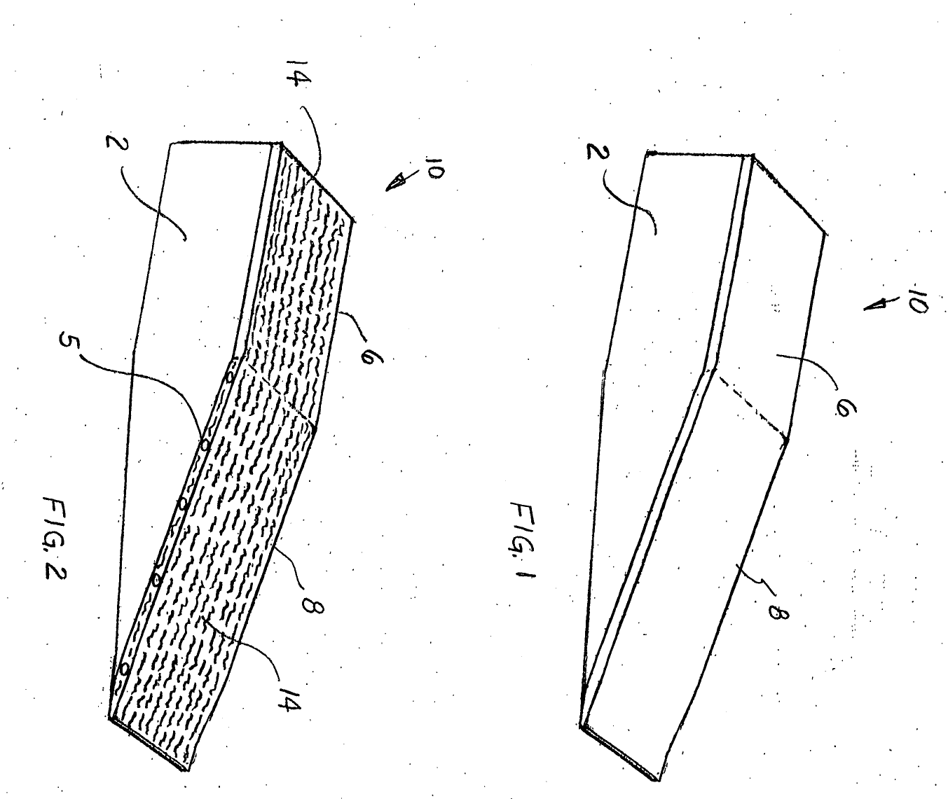

Now reference is made, more particularly, to the drawing Figures. FIGS. 1-7 show various embodiments of the invention.

In a first aspect, shown in FIGS. 1 and 2, the present invention provides a ramp system, generally designated 10, for recreational use. The ramp system 10 comprises at least one member 2 having each of a predetermined shape, a predetermined size and a plurality of substantially planar exterior surfaces, a first portion 4 of the at least one member 2 having an upper surface 6 disposed in a substantially horizontal plane and a second portion 8 disposed in a descending sloped plane, such upper surface of such first member being one of covered and uncovered.

In this embodiment platform and ramp are of unitary construction. Such ramp system 10 has an exterior surface that is hard, shown in FIG. 1, while FIG. 2 shows the ramp system with a soft fabric surface, such as carpet. The ramp systems 10 with hard surfaces would be applicable to skates that are designed for hard surfaces such as skates with a felt base while the ramp systems with carpeted exteriors are designed for skates which have a plastic base. Such covering 14 could be removable in one embodiment. The covering 14 could be attached with snaps 5 as shown in a portion of FIG. 2. This way part of the covering could be replaced if it is worn while the rest could be left alone.

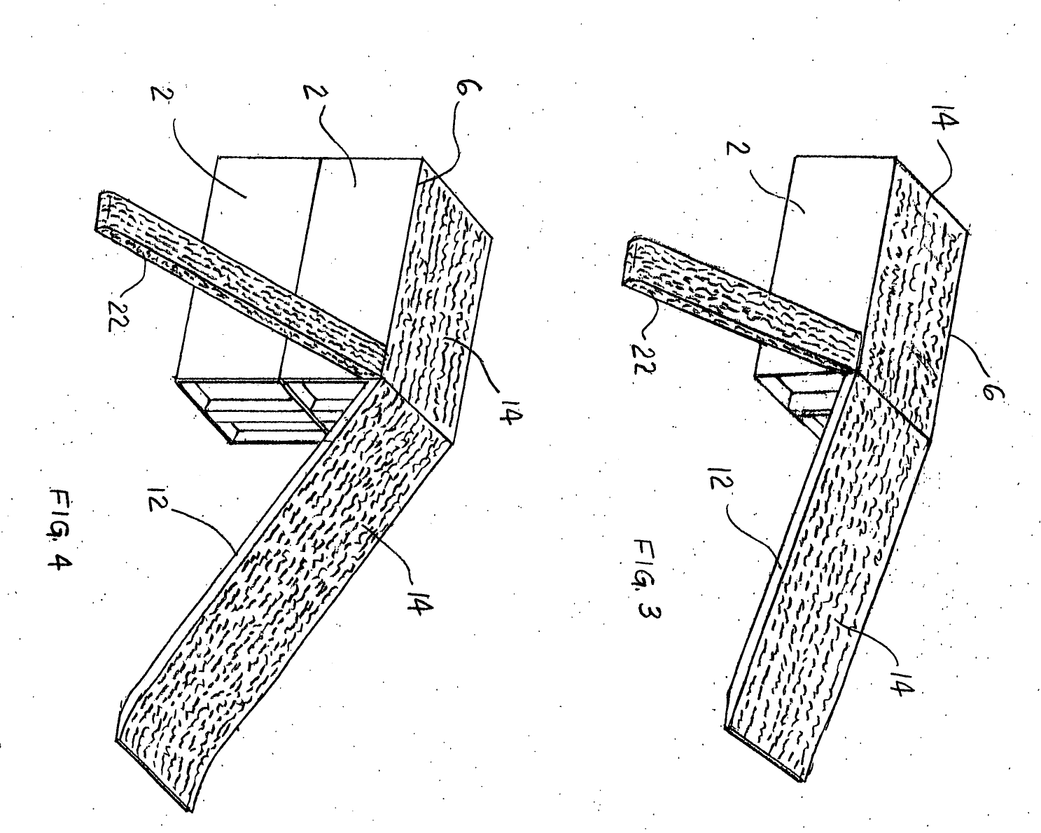

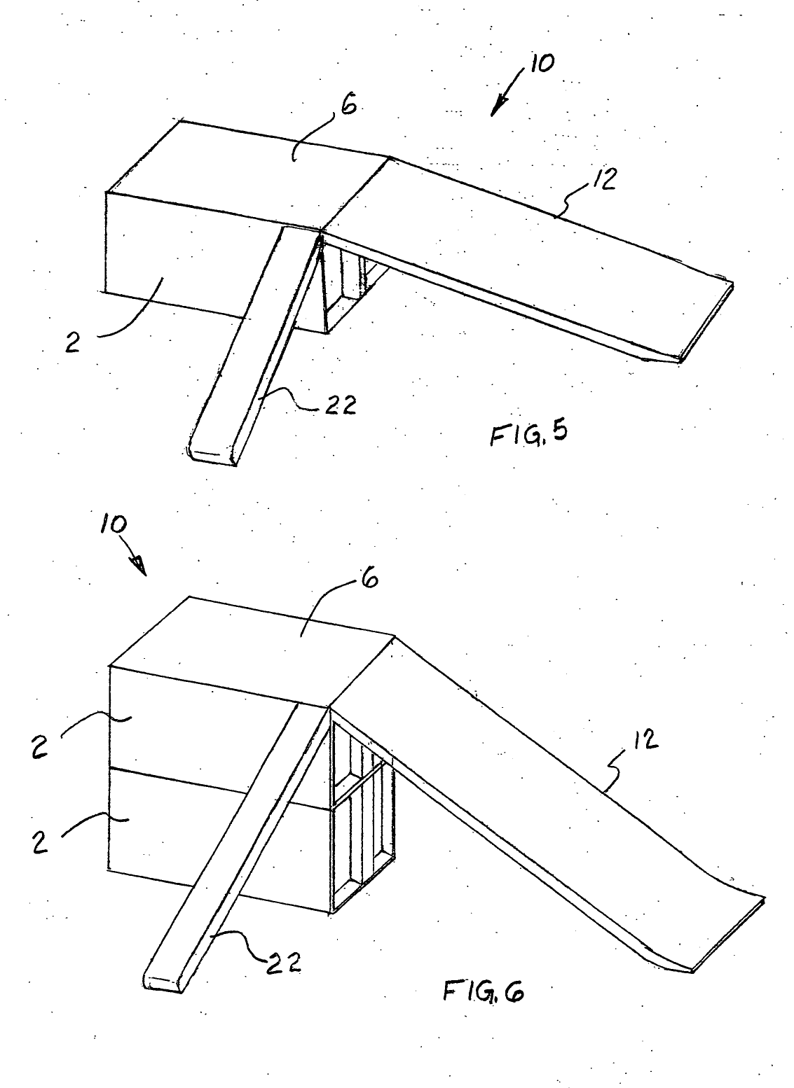

FIGS. 3-7 show a second aspect of the invention in which the fun ramp system 10 is of modular construction. In this embodiment the ramp system 10 comprises at least one first member 2 having each of a first predetermined shape, a predetermined size and a plurality of substantially planar exterior surfaces, the first member 2 has an upper surface 6 which has at least a first portion 4 thereof disposed in a substantially horizontal plane. In this instance the first member 2 does not have a portion that is descending. There is a second member 12 having each of a second predetermined shape, a first predetermined width and a first predetermined length and having a first edge engageable with and extending outwardly from an upper surface of the at least one first member 2, the second member 12 having an inclined surface. FIGS. 5-7 show the embodiment with an exterior hard surface which as discussed previously is designed for use with skates having a felt bottom, while FIGS. 3 and 4 show the exterior surface be covered with fabric 14. FIGS. 4 and 6 also show the embodiment where there are two first members 2 stacked on top of each other to make the ramp system 10 longer and steeper.

The second member 12 is obviously longer or steeper when it is used with more than one first member 2 so that it can reach the floor. This embodiment also shows a third member 22 designed as a side ramp to provide more choices for the user. This third member 22 is narrower than such second member 12. The third member is disposed angularly with respect to the second member. In FIGS. 3 and 4 such third member 22 is disposed at a 90 degree angle from such second member 12.

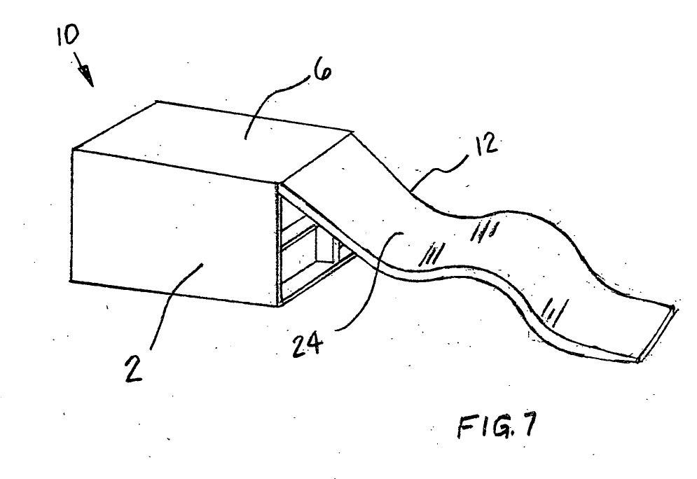

FIG. 7 shows yet another embodiment of the invention wherein the ramp has undulations 24 on it so that the user has a different feel as the user skates down the ramp and provides more excitement to the user.

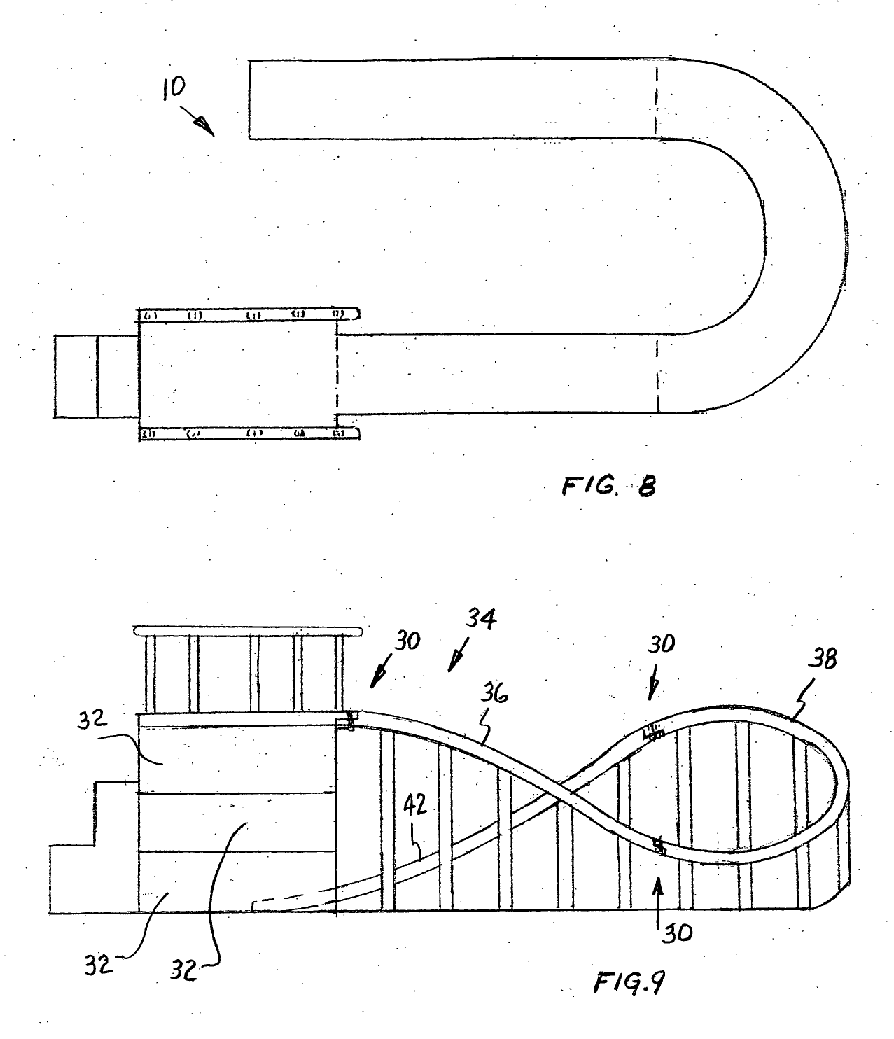

FIGS. 8 and 9 show a completely different concept wherein the ramp system resembles a coaster thereby giving a different thrill to the user of the fun ramps.

In this aspect the present invention provides a ramp system 10 for recreational use. The ramp system 10 comprises at least one first module 32 having a first predetermined shape, a predetermined height and a predetermined size and having a plurality of substantially planar exterior surfaces. There is a second member 34 having a second predetermined shape, a predetermined width and a predetermined length and engageable with an upper surface of the at least one first module 32, the second member 34 extending outwardly therefrom, the second predetermined shape having a first portion 36 extending downwardly, a second portion 38 engageable with the first portion 36 and extending outwardly from a second end of the first portion 36 and rising upwardly therefrom and having an arcuate shape, the second portion 38 being substantially in a shape of a horseshoe, and a third portion 42 having a first end engageable with a second end of the second portion 38 and being sloped downwardly to a supporting surface.

The ramp system 10 further includes means, generally designated 30, for securing such second member 34 to the first member 32 and for securing the first portion 36 of the second member 34 to the second portion 38 and the second portion 38 to the third portion 42. Such means 30 is selected from one of pins, nuts and bolts, and screws.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. A ramp system for recreational use, said ramp system comprising at least one member having each of a predetermined shape, a predetermined size and a plurality of substantially planar exterior surfaces, a first portion of said at least one member having an upper surface disposed in a substantially horizontal plane and a second portion disposed in a descending sloped plane, said upper surface being at least one of covered and uncovered.

2. The ramp system, according to claim 1, wherein said upper surface is covered.

3. The ramp system, according to claim 2, wherein said cover surface is removable.

4. The ramp system, according to claim 1, wherein said upper surface of said first portion and said second portion of said at least one member is covered with fabric.

5. The ramp system, according to claim 4, wherein said fabric covering is carpet.

6. A ramp system for recreational use, said ramp system comprising;
(a) at least one first member having each of a first predetermined shape, a predetermined size and a plurality of substantially planar exterior surfaces, said first member having an upper surface having at least a first portion thereof disposed in a substantially horizontal plane;
(b) a second member having each of a second predetermined shape, a first predetermined width and a first predetermined length and having a first edge engageable with and extending outwardly from an upper surface of said at least one first member, said second member having an inclined surface.

7. The ramp system, according to claim 6, wherein said upper surface of said first member and an upper surface of said second member being selected from one of fabric, wood, plastic and various combinations thereof.

8. The ramp system, according to claim 7, wherein said upper surface of said at least one first member and said second member is covered with fabric.

9. The ramp system, according to claim 8, wherein said fabric covering is carpet.

10. The ramp system, according to claim 6, wherein said ramp system further includes a third member, having a third predetermined shape, a second predetermined width and a second predetermined length, engageable with a side portion of said upper surface of said first member and extending outwardly therefrom, said third member having an inclined surface, said third member being angularly disposed with respect to said second member.

11. The ramp system, according to claim 10, wherein said second predetermined width is narrower than said first predetermined width.

12. The ramp system, according to claim 6, wherein said ramp system includes a plurality of first members.

13. The ramp system, according to claim 12, wherein said plurality of first members is two.

14. The ramp system, according to claim 13, wherein said plurality of first members are placed on top of one another thereby raising a height of said ramp system.

15. The ramp system, according to claim 14, wherein said second member is engageable with an upper surface of an upper on one of said plurality of first members and said first predetermined length is sufficiently long to reach a supporting surface, thereby making the inclined surface a longer surface.

16. The ramp system, according to claim 7, wherein said ramp system further includes a fabric covering for all exterior surfaces of said at least one first member and said second member.

17. The ramp system, according to claim 6, wherein said inclined surface of said second member includes at least one undulation.

18. A ramp system for recreational use, said ramp system comprising;
a. at least one first module having a first predetermined shape, a predetermined height and a predetermined size and having a plurality of substantially planar exterior surfaces;
(b) a second member having a second predetermined shape, a predetermined width and a predetermined length and engageable with an upper surface of said at least one first module, said second member extending outwardly therefrom, said second predetermined shape having a first portion extending downwardly, a second portion engageable with said first portion and extending outwardly from a second end of said first portion and rising upwardly therefrom and having an arcuate shape, said second portion being substantially in a shape of a horseshoe, and a third portion having a first end engageable with a second end of said second portion and being sloped downwardly to a supporting surface.

19. The ramp system, according to claim 18, wherein said ramp system further includes means for securing said second member to said first member and for securing said first portion of said second member to said second portion and said second portion to said third portion.

20. The ramp system, according to claim 19, wherein said means is selected from one of pins, nuts and bolts, and screws.
